(19) United States
(12) Patent Application Publication
(10) Pub. No.: US 2020/0396117 A1
(43) Pub. Date: Dec. 17, 2020

(54) REUSE OPEN CONNECTIONS TO RESOURCES FOR REQUESTERS

(71) Applicant: Microsoft Technology Licensing, LLC, Redmond, WA (US)

(72) Inventors: Yaniv SHAKED, Tel Aviv (IL); Itamar LEVY-RINSKY, Tel Aviv (IL); Amos L. KLEINBERGER, Tel Aviv (IL)

(73) Assignee: Microsoft Technology Licensing, LLC, Redmond, WA (US)

(21) Appl. No.: 16/443,505

(22) Filed: Jun. 17, 2019

(51) Int. Cl. H04L 29/08; H04L 29/06

(52) U.S. Cl. CPC H04L 29/08594; H04L 67/02; H04L 67/42

(57) ABSTRACT

According to examples, an apparatus may include a processor and a non-transitory computer readable medium on which is stored machine readable instructions that may cause the processor to receive a request from a requester, the request identifying a resource. The instructions may also cause the processor to determine whether a connection between the apparatus and the resource is currently open, and based on a determination that the connection is currently open, submit the request to the resource through the open connection to reuse the open connection. The processor may also receive a response to the request from the resource and send the response to the requester.

### BACKGROUND

Processes often establish direct connections with resources, such as servers, databases, websites, and/or the like, in order to submit requests to and receive responses from the resources. To establish the connections, the processes may execute a handshake operation with the resources. After certain periods of inactivity on the connections, the connections between the processes and the resources may be closed. The connections may remain open during periods of activity, but the processes may need to establish new connections, and may need to execute handshake operations, once the connections are closed.

### BRIEF DESCRIPTION OF DRAWINGS

Features of the present disclosure are illustrated by way of example and not limited in the following figure(s), in which like numerals indicate like elements, in which:

FIG. 1 depicts a block diagram of an apparatus that may reuse an open connection to a resource for a requester in accordance with an embodiment of the present disclosure;

FIG. 2 depicts a block diagram of a network environment in which the apparatus depicted in FIG. 1 may be implemented to reuse an open connection to a resource for a requester in accordance with an embodiment of the present disclosure;

FIG. 3 depicts a flow diagram of a method for reusing an open connection to a resource for a requester in accordance with an embodiment of the present disclosure;

FIGS. 4A-4C, collectively, depict a flow diagram of a method for reusing an open connection to a resource for a requester in accordance with an embodiment of the present disclosure; and

FIG. 5 depicts a block diagram of a computer readable medium that may have stored thereon machine readable instructions that when executed by a processor, may cause the processor to reuse an open connection to a resource to submit a request to the resource for a requester in accordance with an embodiment of the present disclosure.

### DETAILED DESCRIPTION

For simplicity and illustrative purposes, the principles of the present disclosure are described by referring mainly to embodiments and examples thereof. In the following description, numerous specific details are set forth in order to provide an understanding of the embodiments and examples. It will be apparent, however, to one of ordinary skill in the art, that the embodiments and examples may be practiced without limitation to these specific details. In some instances, well known methods and/or structures have not been described in detail so as not to unnecessarily obscure the description of the embodiments and examples. Furthermore, the embodiments and examples may be used together in various combinations.

Throughout the present disclosure, the terms “a” and “an” are intended to denote at least one of a particular element. As used herein, the term “includes” means includes but not limited to, the term “including” means including but not limited to. The term “based on” means based at least in part on.

Disclosed herein are apparatuses, methods, and computer readable media that may reuse open connections to resources to submit requests for requesters. Particularly, the present disclosure pertains to a centralized connection manager that may manage submission of requests to resources from requesters and delivery of responses to the requesters from the resources. The centralized connection manager may be realized in the form of a processor (or multiple processors) that may execute a set of instructions to implement the management of the request submissions and the response deliveries. In one regard, instead of informing the requesters of the open connections, the processor disclosed herein may receive requests from the requesters and may submit the requests to the resources.

The processor, e.g., the centralized connection manager, disclosed herein, may receive a request from a requester to access a particular resource. Thus, instead of the requester sending the request directly to the particular resource, the requester may send the request to the processor. Based on receipt of the request, the processor may determine whether a connection between the processor and the particular resource is currently open. The connection may currently be open in instances in which the processor previously performed a handshake operation with the particular resource and the previously established connection is still open, e.g., has not timed out due to inactivity.

According to examples, the processor may maintain a connection pool that includes a number of open, or equivalently, active, connections to resources. Thus, for instance, the processor may determine whether the particular resource identified in a request from a requester is in the connection pool and if so, may reuse the open connection to send the request to the particular resource. However, in instances in which the connection to the resource is not currently open, the processor may open a new connection to the resource and may send the request to the resource through the new connection.

A connection between the processor and the requesters, as used herein, may be defined as a trusted link between the processor and the requesters that may have previously been established. Likewise, a connection between the processor and a resource, as used herein, may be defined as a link between the processor and the resource that may be established following a successful handshake operation. The connection between the processor and the resource may remain open for a predefined length of time following a most recent transaction on the connection. In some examples, the predefined length of time may be about one minute, about two minutes, or the like, although in other examples, the predefined length of time may be other time durations.

A technical problem associated with a requester establishing a direct connection with a resource may be that another requester may not be able to reuse the direct connection, even though the direct connection may be open when the other requester seeks to communicate with the resource, which may result in wasted time for the requesters as well as wasted consumption of computing resources and network bandwidth. That is, the performance of a handshake operation to establish the connections with the resources may waste a large amount of time and may also consume a large amount of computing resources and network bandwidth. Through implementation of the apparatuses, methods, and computer readable media disclosed herein, open connections may be shared across multiple requesters and may thus be reused at an increased level over direct connections by the individual requesters. A technical solution to the technical problem discussed above may thus be that features of the present disclosure may reduce or minimize wasted time, computing resource, and/or network bandwidth consumption in the access by requesters to resources.

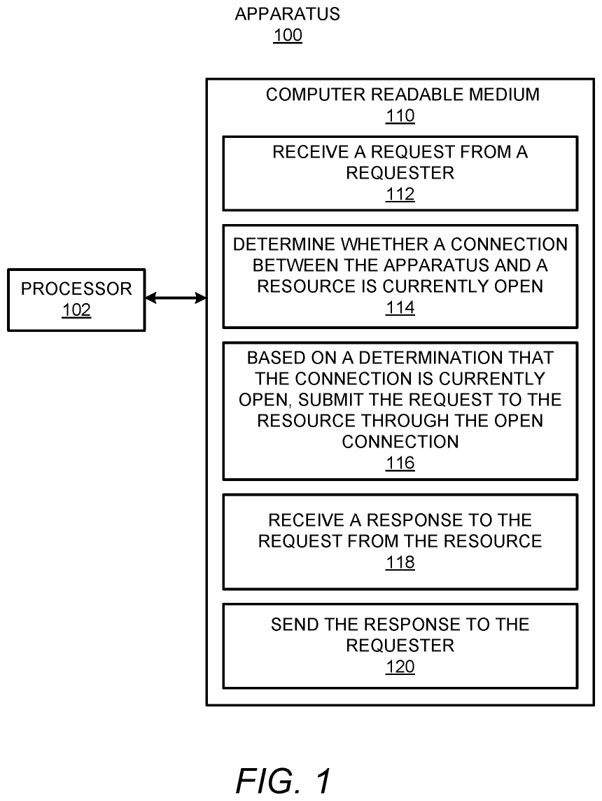

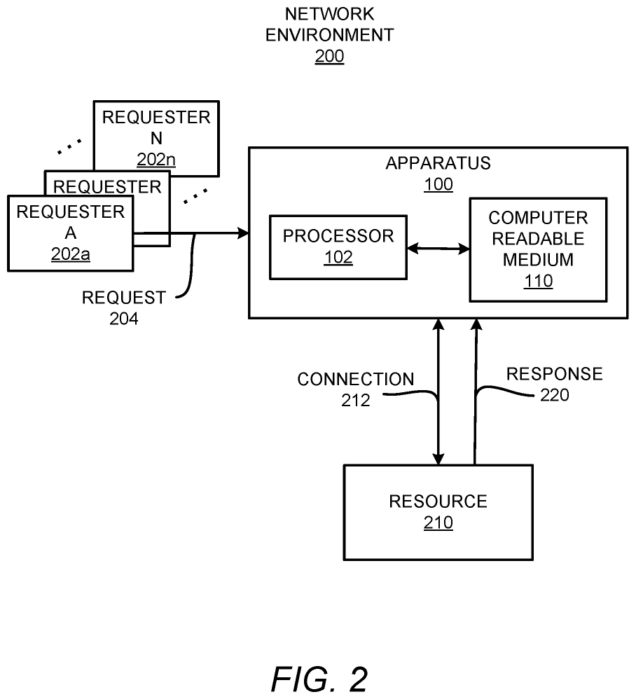

Reference is first made to FIGS. 1 and FIG. 2. FIG. 1 shows a block diagram of an apparatus 100 that may reuse an open connection to a resource for a requester in accordance with an embodiment of the present disclosure. FIG. 2 shows a block diagram of a network environment 200 in which the apparatus 100 depicted in FIG. 1 may be implemented to reuse an open connection to a resource for a requester in accordance with an embodiment of the present disclosure. It should be understood that the apparatus 100 depicted in FIG. 1 and/or the network environment 200 depicted in FIG. 2 may include additional features and that some of the features described herein may be removed and/or modified without departing from the scope of the apparatus 100 and/or the network environment 200.

The apparatus 100 may be a server, a node in a network (such as a data center), a personal computer, a laptop computer, a tablet computer, a smartphone, a network gateway, a network router, an Internet of Things (loT) device, and/or the like. As shown in FIG. 2, the apparatus 100 may be part of a network environment 200 in which the apparatus 100 may communicate with a plurality of requesters 202a-202n, in which the variable “n” may represent a value greater than one. The requesters 202a-202n may be processes, e.g., applications, software, services, programs, or the like. In addition, or alternatively, the requesters 202a-202n may be computing devices, e.g., servers. In any regard, the requesters 202a-202n may request responses from a resource 210 through the apparatus 100. The resource 210 may be a host, a server, a database, a website, and/or the like. Although a single resource 210 is depicted in FIG. 2, it should be understood that the processor 102 may have connections to any number of resources 210.

A requester 202a may seek to obtain information from the resource 210, may request access to the resource 210, may seek to interact with the resource 210, and/or the like. According to examples, instead of directly submitting requests 204 to the resource 210, the requesters 202a-202n may submit requests 204 to the apparatus 100, and particularly, to the processor 102. In this regard, the requesters 202a-202n may be programmed or may otherwise be caused to send the requests 204 to the processor 102 instead of directly to the resource 210. In this regard, the requesters 202a-202n may not establish connections with the resource 210, e.g., the requesters 202a-202n may not perform handshake operations with the resource 210. Instead, the processor 102 may establish a connection 212 with the resource 210, for instance, when the processor 102 receives a request from a requester 202a, and may submit the request to the resource 210 through the connection 212. In addition, the processor 102 may reuse the connection 212 to submit a request 204 in instances in which the connection 212 is open when the processor 102 is to submit the request. In one regard, therefore, the processor 102 may function as a centralized connection manager for the requesters 202a-202n such that the processor 102 may reuse the connection 212 for the requesters 202a-202n when an open connection is available.

In some embodiments, the requesters 202a-202n may be in physically close proximity to the processor 102 such that the requesters 202a-202n and the processor 102 may directly communicate with each other. That is, the requesters 202a-202n and the processor 102 may communicate with each other without communicating via the Internet. For instance, the requesters 202a-202n may be in the same data center, in the same row in a data center, and/or in the same electronics rack as the apparatus 100. In some examples in which the requesters 202a-202n are processes, the requesters 202a-202n may be stored as sets of machine readable instructions in the apparatus 100.

The processor 102 may communicate with the resource 210 via a local area network, a wide area network, the Internet, or a combination of networks. For instance, the apparatus 100 may communicate with the resource 210 via a HyperText Transfer Protocol (HTTP), an HTTP over SSL (or equivalently HTTP Secure) (HTTPS), or the like, connection.

As shown in FIGS. 1 and 2, the apparatus 100 may include a processor 102 and a computer readable medium 110. The processor 102 may be a semiconductor-based microprocessor, a central processing unit (CPU), an application specific integrated circuit (ASIC), a field-programmable gate array (FPGA), and/or other hardware device. Although the apparatus 100 is depicted as having a single processor 102, it should be understood that the apparatus 100 may include additional processors and/or cores without departing from a scope of the apparatus 100. In this regard, references to a single processor 102 as well as to a single machine readable medium 110 may be understood to additionally or alternatively pertain to multiple processors 102 and multiple computer readable mediums 110.

The computer readable medium 110 may be, for example, Random Access memory (RAM), an Electrically Erasable Programmable Read-Only Memory (EEPROM), a storage device, an optical disc, or the like. The computer readable medium 110, which may also be referred to as a machine readable storage medium, may be a non-transitory computer readable storage medium, where the term “non-transitory” does not encompass transitory propagating signals. In any regard, the computer readable medium 110 may have stored thereon machine readable instructions 112-120.

The processor 102 may fetch, decode, and execute the instructions 112 to receive a request 204 from a requester 202a. The request 204 may include an identification of a resource 210. By way of example, the processor 102 may receive a request 204 from the requester 202a to access a particular website and the request 204 may include the uniform resource locator (URL) of the particular website. As another example, the processor 102 may receive a request 204 from the requester 202a to access a particular database and the request 204 may include the internet protocol (IP) address of the particular database.

As discussed herein, the connection between the requester 202a and the apparatus 100, and thus, the processor 102, may be a trusted connection. Thus, for instance, the requester 202a and the apparatus 100 may have previously implemented a security protocol to verify the respective identities of each other. In this regard, the communications between the requester 202a and the apparatus 100 may be through any suitable secure communication protocol. The connection between the requester 202a and the apparatus 100 may also be referenced herein as a first connection.

The processor 102 may fetch, decode, and execute the instructions 114 to determine whether a connection between the apparatus 100 and the resource 210 is currently open. That is, the processor 102 may determine whether a connection 212 to the resource 210 identified in the request 204 is currently open. The connection 212 may be a non-secure connection or a secure connection to the resource 210. For instance, the connection 212 may be a HyperText Transfer Protocol (HTTP), an HTTP over SSL (or equivalently HTTP Secure) (HTTPS), or the like, connection. The connection 212 may be determined to be currently open in instances in which the apparatus 100 previously established the connection 212 with the resource 210 and the connection has not been closed, e.g., has not timed out. Thus, for instance, the connection 212 may be determined to be currently open in instances in which the apparatus 100 previously underwent a handshake operation with the resource 210, e.g., a transmission control protocol (TCP), a secure socket layer (SSL), a transport layer security (TLS), and/or the like, and that connection is currently active. The apparatus 100 may have previously undergone the handshake operation with the resource 210 for the requester 202a or for another requester 202b.

The processor 102 may fetch, decode, and execute the instructions 116 to, based on a determination that the connection 212 is currently open, submit the request 204 to the resource 210 through the open connection 212. In some examples, the request 204 may include an indication as to whether the connection between the apparatus 100 and the resource 210 is to be a secure connection or a non-secure connection. That is, for instance, the request 204 may include an indication that the connection 212 is to be an HTTP connection or that the connection 212 is to be an HTTPS connection. The indication may be included as a mark in the header of the request 204, for example. The determination as to whether the connection 212 is to be a secure or a non-secure connection may be based on the configuration setting of the resource 210. That is, for instance, the resource 210 may require that the connection 212 be a secure connection in order for a requester 202a to access the resource 210. In other examples, the resource 210 may not require that the connection 212 be a secure connection.

According to examples, the request 204 may be for access to a resource 210 that requires a secure connection. In these examples, the requester 202a may downgrade the request 204 from a secure connection (e.g., HTTPS connection) to a non-secure connection (e.g., HTTP connection). In addition, the requester 202a may send the request 204 through the non-secure connection to the apparatus 100. The requester 202a may also include an indication that the apparatus 100 is to upgrade the request 204 to the secure connection prior to the apparatus 100 sending the request 204 to the resource 210.

By way of particular example, an original request may include the requester 202a making a call to requests.get(“https://www.microsoft.com”) and the requester 202a making the request directly. In the examples discussed herein, the requester 202a may instead make the call to the processor 102, such as with a call redirect_requests.get(“https://www.microsoft.com”). The function get ( ) in the library redirect_requests, which may be defined similarly to this def get(url, *args, **kwargs), may need to add the option to connect to the processor 102 instead of directly to the resource 210, as well as any other options arrived from the system, such as, through requests.get(url, proxies={'http': apparatus_address}, *args, **kwargs). In this example, the processor 102 may receive a proxy https request, which may look like: GET http://www.microsoft.com HTTP/1.1

Host: www.microsoft.com
... Other headers ...
X-Upgrade-Request: 1

In the example above, the processor 102 may read the whole request—first line, headers and body (if it exists), and may extract the method (GET) and url (http://www.microsoft.com), and headers. In instances in which the connection to the host (resource 210) is open, the processor 102 may send the request 204 by re-using the open connection. For instance, the processor 102 may employ the following command to create a session object:

session=requests. Session( )# init once

However, in instances in which the connection to the host (resource 210) is closed, the processor 102 may open a new connection to the host. In these instances, the processor 102 may send the request 204 to the resource 210 through the new connection.

The processor 102 may fetch, decode, and execute the instructions 118 to receive a response 220 from the resource 210. Thus, for instance, the resource 210 may receive the request 204 from the processor 102 and may process the request 204 to generate the response 220. In addition, the resource 210 may send the response 220 to the processor 102. The response 220 may include data and/or approval for the processor 102 to access the resource 210. For instance, the response 220 may include data that may be used to display a webpage of the resource 210. The processor 102 may receive the response 220 by employing the following command: response =session.get(url, headers).

The processor 102 may fetch, decode, and execute the instructions 120 to send the response 220 to the requester 202a. The processor 102 may send the response 220 to the requester 202a through the connection (e.g., first connection) through which the processor 102 received the request 204 from the requester 202a. The processor 102 may send the response 220 via the following command:

response_buf = ‘{ } { } { }\r\n{ }\r\n\r\n{ }’.format(response.http_version,
response.response_code, response.reason, ‘\r\n’.join([‘{ }: { }’.format(k, v) for
response.headers]), response.content)
proxy_connection.send_all(response_buff).

Instead of the machine readable instructions 112-120, the apparatus 100 may include hardware logic blocks that may perform functions similar to the instructions 112-120. In other examples, the apparatus 100 may include a combination of instructions and hardware logic blocks to implement or execute functions corresponding to the instructions 112-120. In any of these examples, the processor 102 may implement the hardware logic blocks and/or execute the instructions 112-120. As discussed herein, the apparatus 100 may also include additional instructions and/or hardware logic blocks such that the processor 102 may execute operations in addition to or in place of those discussed above with respect to FIG. 1.

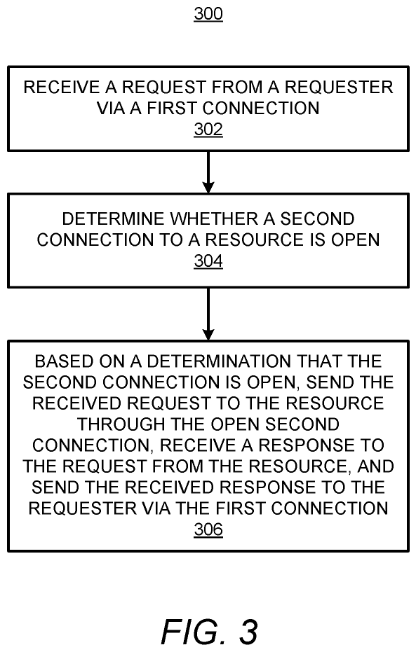

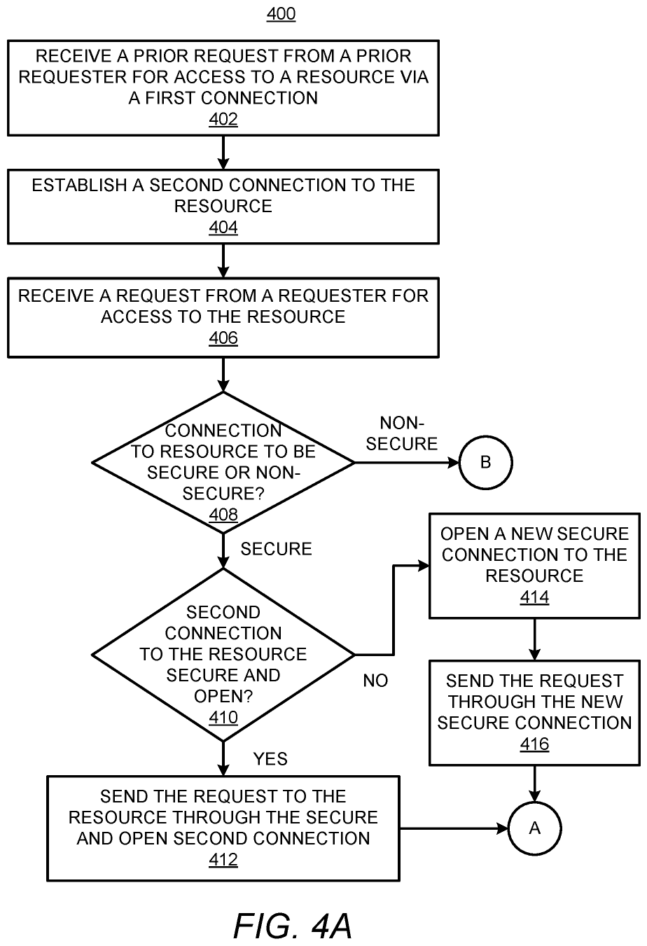

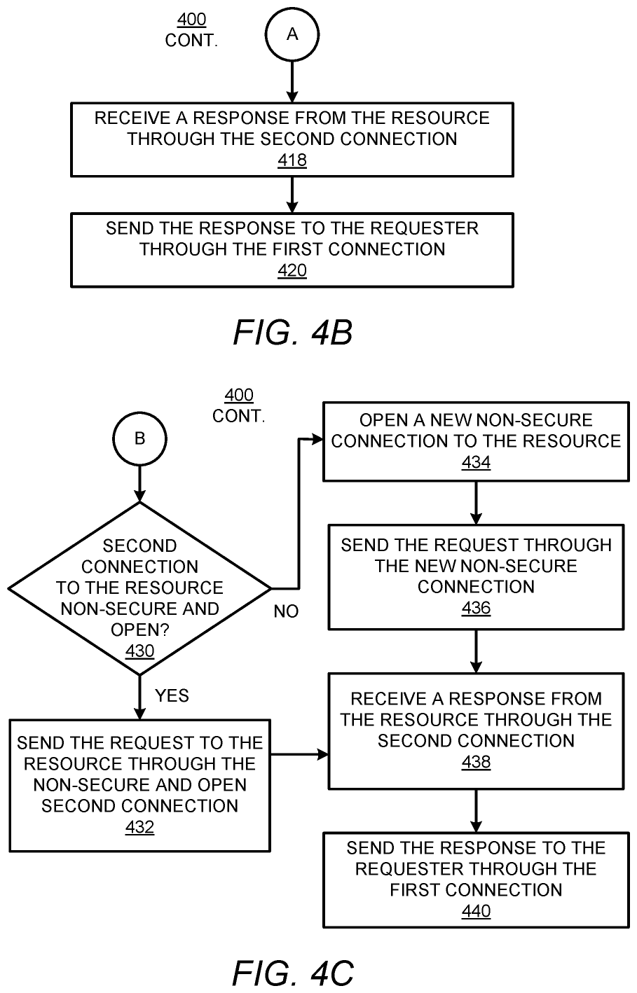

Various manners in which the processor 102 of the apparatus 100 may operate are discussed in greater detail with respect to the methods 300 and 400 respectively depicted in FIGS. 3 and 4. Particularly, FIG. 3 depicts a flow diagram of a method 300 for reusing an open connection to a resource 210 for a requester 202a in accordance with an embodiment of the present disclosure. In addition, FIGS. 4A-4C, collectively, depict a flow diagram of a method 400 for reusing an open connection to a resource 210 for a requester 202a in accordance with an embodiment of the present disclosure. It should be understood that the methods 300 and 400 depicted in FIGS. 3 and 4 may include additional operations and that some of the operations described therein may be removed and/or modified without departing from the scopes of the methods 300 and 400. The descriptions of the methods 300 and 400 are made with reference to the features depicted in FIGS. 1-2 for purposes of illustration.

At block 302, the processor 102 may receive a request 204 from a requester 202a via a first connection. The first connection may be a trusted connection between the processor 102 and the requester 204. The request 204 may include an identification of a resource 210 that the requester 202a is to access. As shown in FIG. 1, the processor 102 may also receive additional requests from a plurality of requesters 202a-202n. In one regard, the processor 102 may operate as a centralized connection manager for the plurality of requesters 202a-20n. The description of the operations that the processor 102 may implement for or on behalf the requester 202a may thus also be applicable to the other requesters 202b-202n.

At block 304, the processor 102 may determine whether a second connection 212 to the resource 210 is open. As shown in FIG. 2, the second connection 212 may differ from the first connection. By way of particular example, the first connection may be established over a switch fabric, a network bus, or the like and the second connection 212 may be established over a wide area network, the Internet, or the like. In any regard, the processor 102 may determine that the second connection 212 to the resource 210 is open in any of a number of manners. For instance, the processor 102 may determine that the second connection 212 is open based on a determination that an idle time period during which the second connection 212 is known to be open following communication of data over the second connection 212 has not expired. As another example, the processor 102 may determine that the second connection 212 is open based on a determination that the resource 210 returned a response to test packet submitted through the second connection 212.

At block 306, the processor 102 may, based on a determination that the second connection 212 to the resource 210 is open, send the received request 204 to the resource 210 through the open second connection 212. The processor 102 may also receive a response 220 to the request 204 from the resource 210 and may send the received response 220 to the requester 202a via the first connection.

Turning now to FIG. 4, at block 402, the processor 102 may receive a prior request from a prior requester for access to a resource 210 via a first connection. As used herein, the first connection may refer to each or all of the connections between the processor 102 and the requesters 202a-202b. In any case, the processor 102 may receive the prior request for access to the resource 210 prior to a request from a current requester 202a. The prior requester may be the current requester 202a or a different requester 202b. In any event, the processor 102 may not have an open connection to the resource 210 when the prior request is received. As such, the processor 102 may establish a second connection 212 to the resource 210, as indicated at block 404. The processor 102 may establish the second connection 212 in any of the manners discussed herein, e.g., the processor 102 may perform a handshake operation with the resource 210. For instance, the processor 102 may perform a TCP, an SSL, a TLS, and/or the like, handshake operation with the resource 210 to establish the connection 212.

At block 406, the processor 102 may receive a request 204 from a requester 202a via a first connection between the processor 102 and the requester 202a. The request 204 may include an identification of the resource 210 that the requester 202a seeks or is to access. In some examples, and as discussed herein, the requester 202a may downgrade the connection type of the request submitted to the processor 102 from a secure connection to a non-secure connection. In addition, the request 204 may include an indication as to whether the connection to the resource 210 is to be a secure connection or a non-secure connection.

At block 408, the processor 102 may determine whether the connection to the resource 210 is to be a secure connection or a non-secure connection. The processor 102 may make this determination based on information included in the request 204 pertaining to whether the connection to the resource 210 is to be secure or non-secure.

Based on a determination that the connection to the resource 210 is to be secure, at block 410, the processor 102 may determine whether a second connection 212 to the resource 210 is secure and open. That is, the processor 102 may determine whether a second connection to the resource 210 is both open and secure, e.g., complies with HTTPS. Based on a determination that the second connection 212 to the resource 210 is secure and open, at block 412, the processor 102 may send the request 204 to the resource 210 through the secure and open second connection 212. In some examples, the second connection 212 may be open if a predefined idle time period following the establishment of the second connection 212 to the resource 210, following the communication of data across the second connection 212, or following another idle time period reset event, has not elapsed.

However, at block 410, based on a determination that the connection to the resource 210 is not secure and/or is closed, at block 414, the processor 102 may open a new secure connection to the resource 210. In addition, at block 416, the processor 102 may send the request 204 to the resource 210 through the new secure connection. Following either of blocks 412 and 416, at block 418 (FIG. 4B), the processor 102 may receive a response 220 from the resource 210 through the second connection 212. In addition, at block 420, the processor 102 may send the response 220 to the requester 202a through the first connection.

With reference back to block 408 (FIG. 4A), based on a determination that the connection to the resource 210 is to be non-secure, e.g., to comply with HTTP, at block 430 (FIG. 4C), determine whether a second connection 212 to the resource 210 is non-secure and open. That is, the processor 102 may determine whether a second connection to the resource 210 is both open and non-secure, e.g., complies with HTTP. Based on a determination that the second connection 212 to the resource 210 is non-secure and open, at block 432, the processor 102 may send the request 204 to the resource 210 through the non-secure and open second connection 212. In some examples, the second connection 212 may be open if a predefined idle time period following the establishment of the second connection 212 to the resource 210, following the communication of data across the second connection 212, or following another idle time period reset event, has not elapsed.

However, at block 430, based on a determination that the connection to the resource 210 is secure and/or is closed, at block 434, the processor 102 may open a new non-secure connection to the resource 210. In addition, at block 436, the processor 102 may send the request 204 to the resource 210 through the new non-secure connection. Following either of blocks 432 and 436, at block 438, the processor 102 may receive a response 220 from the resource 210 through the second connection 212. In addition, at block 440, the processor 102 may send the response 220 to the requester 202a through the first connection.

Although the apparatus 100, the processor 102, and the methods 300 and 400 are described herein with respect to a single resource 210, it should be understood that similar descriptions may be applicable to multiple resources 210. As such, for instance, the processor 102 may receive requests directed to multiple resources 210 and the processor 102 may determine whether open, e.g., active, connections are respectively available to each of the multiple resources 210. In addition, for the resources 210 to which the processor 102 has an open connection, the processor 102 may reuse the open connections. That is, the processor 102 may avoid having to establish a new connection and may reuse open connections when they are available. In this regard, the processor 102 may reduce or minimize the number of times that the processor 102 performs new connection establishment operations, which may reduce the amount of wasted time as well as the amount of processing resources consumed by the processor 102 in managing access by the requesters 202a-202n to resources 210. The reduction in the number of times that new connection establishment operations are performed may also reduce the consumption of network bandwidth.

Some or all of the operations set forth in the methods 300 and 400 may be included as utilities, programs, or subprograms, in any desired computer accessible medium. In addition, the methods 300 and 400 may be embodied by computer programs, which may exist in a variety of forms both active and inactive. For example, they may exist as machine readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

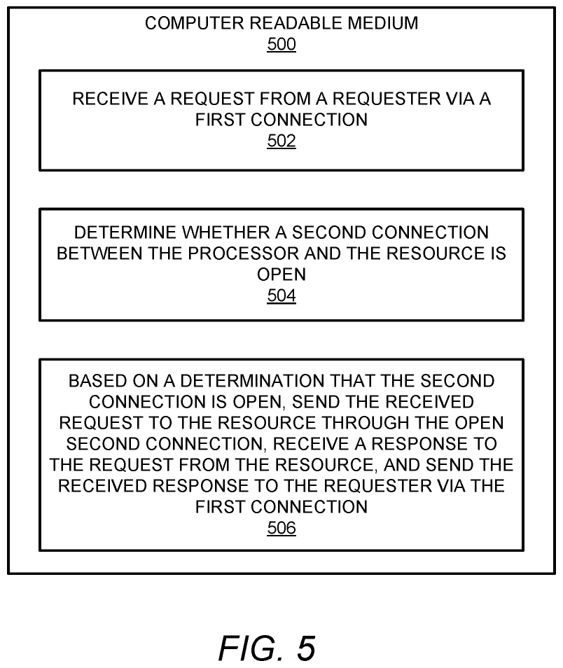

Turning now to FIG. 5, there is shown a block diagram of a computer readable medium 500 that may have stored thereon machine readable instructions that when executed by a processor, may cause the processor to reuse an open connection to a resource 210 to submit a request to the resource 210 for a requester 202a according to an embodiment of the present disclosure. It should be understood that the computer readable medium 500 depicted in FIG. 5 may include additional instructions and that some of the instructions described herein may be removed and/or modified without departing from the scope of the computer readable medium 500 disclosed herein. The computer readable medium 500 may be a non-transitory computer readable medium. The term “non-transitory” does not encompass transitory propagating signals.

The computer readable medium 500 may have stored thereon machine readable instructions 502-506 that a processor, such as the processor 102 depicted in FIGS. 1 and 2, may execute. The computer readable medium 500 may be an electronic, magnetic, optical, or other physical storage device that contains or stores executable instructions. The computer readable medium 500 may be, for example, Random Access memory (RAM), an Electrically Erasable Programmable Read-Only Memory (EEPROM), a storage device, an optical disc, and the like.

The processor may fetch, decode, and execute the instructions 502 to receive a request 204 from a requester 202a via a first connection. As discussed herein, the request may include an identification of a resource 210 that the requester 202a seeks to access, in which the requester 202a may be one of a plurality of requesters 202a-202n from which the processor may receive requests 204. In other words, the processor may manage access by a plurality of requesters 202a-202n to a plurality of resources 210, and more particularly may manage the reuse of connections between the processor and the resources 210 for the requesters 202a-202n.

The processor may fetch, decode, and execute the instructions 504 to determine whether a second connection 212 between the processor and the resource 210 is open. The processor may fetch, decode, and execute the instructions 506 to, based on a determination that the second connection 212 to the resource is open, send the received request 204 to the resource 210 through the open second connection 212, receive a response 220 to the request 204 from the resource 210, and send the received response 220 to the requester 202a via the first connection.

As discussed herein, the request 204 may include an indication as to whether a connection to the resource 210 is to be secure or non-secure. In addition, the processor may determine whether the second connection 212 complies with the indication in the request 204 regarding whether the connection to the resource 210 is to be a secure or a non-secure connection. Based on a determination that the second connection 212 complies with the secure or the non-secure connection indication, the processor may use the second connection 212 to send the request 204 to the resource 210. However, based on a determination that the second connection 212 does not comply with the secure or the non-secure connection indication, open a new second connection to the resource 210 and use the new second connection to send the request 204 to the resource 210.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

1. An apparatus comprising:
a processor; and
a non-transitory computer readable medium on which is stored machine readable instructions that are to cause the processor to:
receive a request from a requester, the request identifying a resource and indicating that a connection to the resource is to be one of a secure connection or a non-secure connection;
determine whether a connection between the apparatus and the resource that meets the indicated connection is currently open;
based on a determination that the connection that meets the indicated connection is currently open, submit the request to the resource through the open connection to reuse the open connection;
receive a response to the request from the resource; and
send the received response to the requester.

2. The apparatus of claim 1, wherein the requester comprises a process or a server.

3. The apparatus of claim 1, wherein the instructions are further to cause the processor to:
based on a determination that a connection that meets the indicated connection between the apparatus and the resource is not currently open,
open a new connection that meets the indicated connection to the resource;
submit the request to the resource through the new connection;
receive a response to the request submitted through the new connection from the resource; and
send the response received through the new connection to the requester.

4. The apparatus of claim 1, wherein the instructions are further to cause the processor to:
receive a prior request from a prior requester, the prior request identifying the resource; and
establish a connection to the resource, wherein the open connection comprises the connection established to the resource for the prior requester.

5. The apparatus of claim 1, wherein the open connection comprises a secure connection and wherein the request from the requester is received over a non-secure connection.

6. The apparatus of claim 5, wherein the apparatus receives the request via the non-secure connection and wherein the request includes an indication that the connection to the resource is to be made via the secure connection.

7. The apparatus of claim 1, wherein the open connection between the apparatus and the resource is to close following a predefined length of time during which the open connection remains idle and the predefined length of time is to reset following the submission of the request to the resource through the open connection.

8. The apparatus of claim 1, wherein the instructions are further to cause the processor to:
determine that the request indicates that the connection to the resource is to be the secure connection;
determine whether a secure connection between the apparatus and the resource is currently open to determine whether the connection between the apparatus and the resource is currently open;
based on a determination that the secure connection is currently open, submit the request to the resource through the open secure connection to reuse the open secure connection;
receive a response to the request from the resource; and
send the received response to the requester.

9. The apparatus of claim 8, wherein the instructions are further to cause the processor to:
based on a determination that the secure connection is not currently open,
open a new secure connection to the resource;
submit the request to the resource through the new secure connection;
receive a response to the request submitted through the new secure connection from the resource; and
send the response received through the new secure connection to the requester.

10. The apparatus of claim 1, wherein the instructions are further to cause the processor to:
determine that the request indicates that the connection to the resource is to be the non-secure connection;
determine whether a non-secure connection between the apparatus and the resource is currently open to determine whether the connection between the apparatus and the resource is currently open;
based on a determination that the non-secure connection is currently open, submit the request to the resource through the open non-secure connection to reuse the open non-secure connection; and
based on a determination that the non-secure connection is not currently open, open a new non-secure connection to the resource.

11. A method comprising:
receiving, by a processor, a request from a requester via a first connection, the request including an identification of a resource that the requester is to access and an indication that a connection to the resource is to be one of a secure connection or a non-secure connection, wherein the processor is to receive additional requests from a plurality of requesters;
determining, by the processor, whether a second connection to the resource that meets the indicated connection is open, wherein the second connection differs from the first connection; and
based on a determination that the second connection that meets the indicated connection to the resource is open,
sending, by the processor, the received request to the resource through the open second connection;
receiving, by the processor, a response to the request from the resource; and
sending, by the processor, the received response to the requester via the first connection.

12. The method of claim 11, further comprising:
based on a determination that a second connection that meets the indicated connection to the resource is not open,
opening a new second connection that meets the indicated connection to the resource;
sending the request to the resource through the new second connection;
receiving a response to the request submitted through the new second connection from the resource; and
sending the response received through the new second connection to the requester via the first connection.

13. The method of claim 11, further comprising:
receiving a prior request from a prior requester, the prior request identifying the resource; and
establishing the second connection to the resource, wherein determining whether a second connection to the resource is open comprises determining whether the second connection established for the prior requester is open.

14. The method of claim 11, further comprising:
determining that the request indicates that a connection to the resource is to be the secure connection;
determining whether the second connection is a secure connection and is open; and
based on a determination that the second connection is a secure connection and is open, sending the request to the resource through the second connection to reuse the second connection.

15. The method of claim 14, further comprising:
based on a determination that the second connection is not the secure connection or that the second connection is not open,
opening a new secure connection to the resource; and
sending the request to the resource through the new secure connection.

16. The method of claim 11, further comprising:
determining that the request indicates that a connection to the resource is to be the non-secure connection;
determine whether the second connection is a non-secure connection and is open; and
based on a determination that the second connection is a non-secure connection and is open, sending the request to the resource through the second connection to reuse the second connection.

17. The method of claim 16, further comprising:
based on a determination that the second connection is a secure connection or is not open,
opening a new non-secure connection to the resource; and
sending the request to the resource through the new non-secure connection.

18. A non-transitory computer readable medium on which is stored machine readable instructions that when executed by a processor, cause the processor to:
receive a request from a requester via a first connection, the request including an identification of a resource that the requester seeks to access and including an indication that a type of the connection to the resource is to be one of a secure connection or a non-secure connection, wherein the requester is one of a plurality of requesters from which the processor is to receive requests;
determine whether a second connection between the processor and the resource that meets the indicated type of connection is open; and
based on a determination that the second connection to the resource that meets the indicated type of connection is open,
send the received request to the resource through the open second connection;
receive a response to the request from the resource; and
send the received response to the requester via the first connection.

19. The computer readable medium of claim 18, wherein the instructions are further to cause the processor to:
determine whether the second connection complies with the indication in the request regarding whether the connection to the resource is to be a secure or a non-secure connection;
based on a determination that the second connection complies with the secure or the non-secure connection indication, use the second connection to send the request to the resource; and
based on a determination that the second connection does not comply with the secure or the non-secure connection indication, open a new second connection to the resource and use the new second connection to send the request to the resource.

20. The computer readable medium of claim 19, wherein the non-secure connection is a hypertext transfer protocol (HTTP) connection and the secure connection is an HTTP over secure socket layer (HTTPS) connection.
